(19) United States
(12) Patent Application Publication
(10) Pub. No.: US 2011/0164183 A1
(43) Pub. Date: Jul. 7, 2011

(54) VIDEO PROCESSING APPARATUS AND VIDEO PROCESSING METHOD

(76) Inventor: Takashi Wada, Kumagaya-shi (JP)

(21) Appl. No.: 12/848,760

(22) Filed: Aug. 2, 2010

(30) Foreign Application Priority Data
Jan. 6, 2010 (JP) 2010-001601

(51) Int. Cl. H04N 5/445

(52) U.S. Cl. 348/563; 348/604; 348/E05.099

(57) ABSTRACT

A video processing apparatus that includes an interface capable of transmitting a video signal and type information indicating a content of the video signal and reproduces and displays the video signal, includes: a setting reception module to accept, from a user, a setting of one of automatic signal processing of the video signal and manual signal processing of the video signal, the automatic signal processing being based on at least environment information indicating a surrounding environment and processing content of the manual signal processing being preset by the user; a judgment module to judge whether the setting of one of the automatic signal processing and the manual signal processing has been accepted by the setting reception module; and a signal processing module to execute, when it is judged that the setting of the automatic signal processing has been accepted, the automatic signal processing based on the environment information and the type information.

### CROSS-REFERENCE TO RELATED APPLICATIONS

This application is based upon and claims the benefit of priority from Japanese Patent Application No. 2010-001601, filed on Jan. 6, 2010; the entire contents of which are incorporated herein by reference.

### FIELD

An embodiment described herein basically relates to a video processing apparatus and a video processing method that are capable of automatically adjusting an image quality and a sound quality based on a video type.

### BACKGROUND

In video processing apparatuses such as a television, it is possible to adjust an image quality and a sound quality based on video characteristics and preferences of viewers. For example, regarding a video with strenuous movements such as a video of a sports program and a video with relatively-stable movements such as a video of a drama and a movie, a video with a higher realistic sensation and comfort can be provided with more appropriate image quality settings and sound quality settings.

On the other hand, since a task of adjusting an image quality and a sound quality for each program is troublesome, many viewers hardly change standard settings.

### BRIEF DESCRIPTION OF THE DRAWINGS

FIG. 1 is a block diagram showing a structure of a video processing apparatus according to an embodiment.

FIG. 2 is a block diagram showing a structure of the video processing apparatus according to the embodiment.

FIG. 3 is a flowchart showing an operation of the video processing apparatus according to the embodiment.

FIG. 4 is a diagram showing an example of a setting table of the video processing apparatus according to the embodiment.

FIG. 5 is a diagram showing an example of a setting menu of the video processing apparatus according to the embodiment.

FIG. 6 is a diagram showing an example of an automatic adjustment confirmation menu of the video processing apparatus according to the embodiment.

### DETAILED DESCRIPTION

According to an embodiment, a video processing apparatus includes an interface capable of transmitting a video signal and type information indicating a content of the video signal and reproduces and displays the video signal. The video processing apparatus includes a setting reception module to accept, from a user, a setting of one of automatic signal processing of the video signal and manual signal processing of the video signal, the automatic signal processing being based on at least environment information indicating a surrounding environment and processing content of the manual signal processing being preset by the user. The video processing apparatus also includes a judgment module to judge whether the setting of one of the automatic signal processing and the manual signal processing has been accepted by the setting reception module. The video processing apparatus also includes a signal processing module to execute, when it is judged that the setting of the automatic signal processing has been accepted, the automatic signal processing based on the environment information and the type information.

According to another embodiment, a video processing method uses a video processing apparatus that includes an interface capable of transmitting a video signal and type information indicating a content of the video signal and reproduces and displays the video signal. The video processing method includes accepting from a user, by a setting reception module, a setting of one of automatic signal processing of the video signal and manual signal processing of the video signal, the automatic signal processing being based on at least environment information indicating a surrounding environment and processing content of the manual signal processing being preset by the user. The video processing method also includes judging, by a judgment module, whether the setting of one of the automatic signal processing and the manual signal processing has been accepted by the setting reception module, and executing, by a signal processing module, when it is judged that the setting of the automatic signal processing has been accepted, the automatic signal processing based on the environment information and the type information.

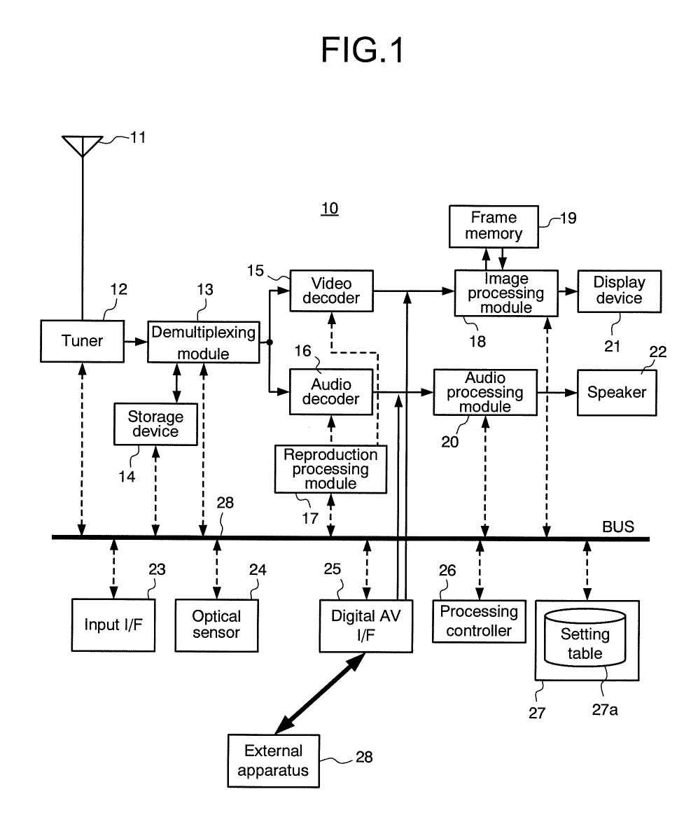

Hereinafter, an embodiment will be described with reference to the drawings. FIG. 1 is a functional block diagram of a television receiver apparatus 10 as a video processing apparatus of this embodiment.

As shown in FIG. 1, the television receiver apparatus 10 of this embodiment is, for example, a digital television receiver apparatus including a recording function. The television receiver apparatus 10 includes an antenna 11, a tuner 12, a demultiplexing module 13, a storage device 14, a video decoder 15, an audio decoder 16, a reproduction processing module 17, an image processing module 18, a frame memory 19, an audio processing module 20, a display device 21 such as a liquid crystal display that is capable of displaying a digital video signal, and a speaker 22 that includes a D/A conversion function and is capable of outputting a digital audio signal.

The television receiver apparatus 10 also includes an input interface (I/F) 23 constituted of a remote controller set, a switch, and the like, an optical sensor 24 that detects ambient brightness, a digital AV interface (I/F) 25 connected to an external apparatus 28, a processing controller 26 that performs image quality processing and sound quality processing, a flash ROM (EEPROM) 27 that stores a setting table 27a defining a predetermined image quality setting and sound quality setting, and the like.

The tuner 12 tunes in on a desired broadcast wave (broadcast station) out of, for example, digital broadcast waves that are taken in by the antenna 11. It should be noted that broadcast waves of digital broadcast waves are not limited to those that are taken in by the antenna and may instead be taken in from a cable television station or the like via a cable.

The demultiplexing module 13 separates a video signal and an audio signal multiplexed on the broadcast waves and outputs them to the video decoder 15 and the audio decoder 16, respectively. The reproduction processing module 17 controls the video decoder 15 and the audio decoder 16 to reproduce (decode) a content separated by the demultiplexing module 13.

The video decoder 15 decodes the video signal separated by the demultiplexing module 13 and outputs the decoded digital video signal to the image processing module 18. On the other hand, the audio decoder 16 decodes the audio signal separated by the demultiplexing module 13 and outputs the decoded digital audio signal to the audio processing module 20. The image processing module 18 and the audio processing module 20 perform predetermined image processing and audio processing on the decoded digital video signal and digital audio signal and output the processed video signal and audio signal to the display device 21 and the speaker 22, respectively.

The storage device 14 includes, for example, a hard disk drive device and an optical disc drive device capable of writing in a recordable optical disc, and is capable of storing received contents such as a broadcast program that are not yet decoded by the video decoder 15 and the audio decoder 16. It should be noted that the storage device 14 may be an external storage device such as a DVD (registered trademark) recorder and an external HDD, or may be a built-in storage device such as a built-in HDD and a flash memory.

The input interface (I/F) 23 is an interface that receives a user instruction, such as an infrared remote controller and a switch provided on a casing. The optical sensor 24 is a light detection device such as a photodiode and a phototransistor. The optical sensor 24 detects ambient brightness and provides an index in an image quality adjustment.

The digital AV interface (I/F) 25 is a signal input/output interface such as an HDMI (High-Definition Multimedia Interface: registered trademark). The digital AV interface 25 is capable of exchanging various signals with the external apparatus 28 and is capable of exchanging signals on what kind of contents are to be transmitted from the connected external apparatus 28 in particular as needed. The digital AV interface 25 receives a digital video signal, a digital audio signal, a control signal, and the like and sends the digital video signal and the digital audio signal to the image processing module 18 and the audio processing module 20, respectively.

The processing controller 26 controls image processing and audio processing in the image processing module 18 and the audio processing module 20. The flash ROM 27 stores the setting table 27a defining processing contents of the image processing module 18 and the audio processing module 20.

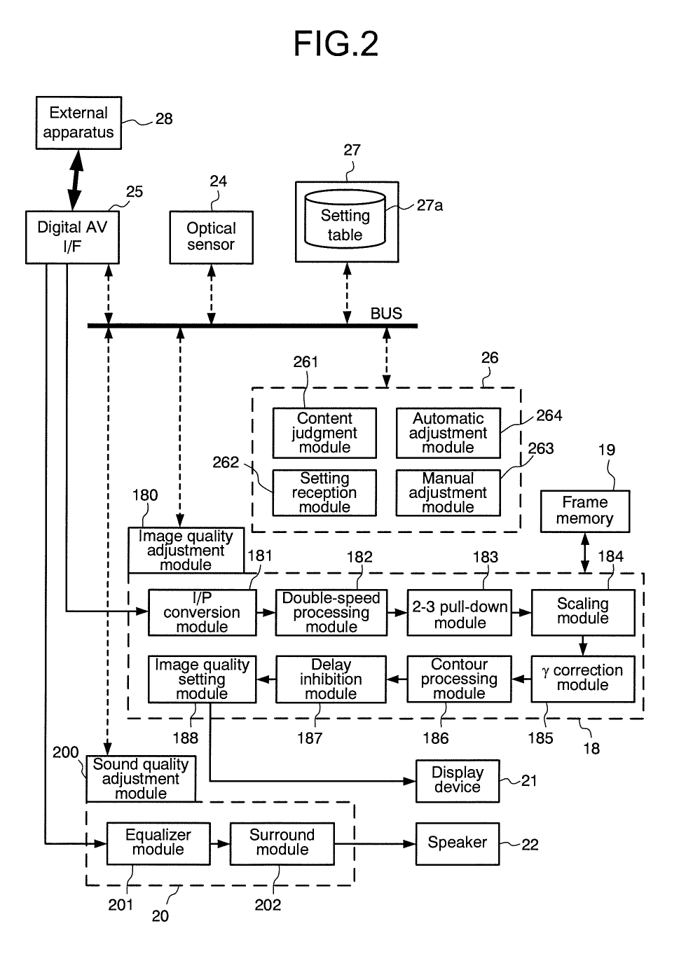

Next, referring to FIG. 2, functional structures of the image processing module 18, the audio processing module 20, and the processing controller 26 of the television receiver apparatus 10 of this embodiment will be described in detail.

As shown in FIG. 2, the image processing module 18 of this embodiment includes an image quality adjustment module 180, an I/P conversion module 181, a double-speed processing module 182, a 2-3 pull-down module 183, a scaling module 184, a γ correction module 185, a contour processing module 186, a delay inhibition module 187, and an image quality setting module 188.

The I/P conversion module 181 performs an interlace/progressive conversion on a digital video signal sent from the video decoder 15 or the digital AV interface 25. The double-speed processing module 182 performs double-speed processing for smoothening a movement of a video by complementing a predetermined number of frames in the digital video signal output from the I/P conversion module 181. The 2-3 pull-down module 183 converts a video signal of a movie film or the like output from the double-speed processing module 182 into a television video signal.

The scaling module 184 converts a display size of the digital video signal output from the 2-3 pull-down module 183 into a predetermined size. The γ correction module 185 performs a gamma correction on the digital video signal output from the scaling module 184. The contour processing module 186 performs processing for emphasizing a contour of a video on the digital video signal output from the γ correction module 185. The delay inhibition module 187 performs waveform correction processing on the digital video signal output from the contour processing module 186 in accordance with operational characteristics of the display device 21. The image quality setting module 188 performs an image quality adjustment on brightness, a color temperature, sharpness, and the like based on a detection result of the optical sensor 24 or a setting instruction from a user received via the input interface 23. The image quality adjustment module 180 controls signal processing operations of each of the I/P conversion module 181, the double-speed processing module 182, the 2-3 pull-down module 183, the scaling module 184, the γ correction module 185, the contour processing module 186, the delay inhibition module 187, and the image quality setting module 188 and sends the digital video signal output from the image quality setting module 188 to the display device 21.

On the other hand, the audio processing module 20 of this embodiment includes a sound quality adjustment module 200, an equalizer module 201, and a surround module 202. The equalizer module 201 corrects frequency characteristics of a digital audio signal sent from the audio decoder 16 or the digital AV interface 25. The surround module 202 adds a surround effect to the digital audio signal output from the equalizer module 201. The sound quality adjustment module 200 controls signal processing operations of the equalizer module 201 and the surround module 202 and sends the audio signal output from the surround module 202 to the speaker 22.

Moreover, the processing controller 26 of this embodiment includes a content judgment module 261, a setting reception module 262, a manual adjustment module 263, and an automatic adjustment module 264.

The content judgment module 261 receives content information sent from the external apparatus 28 via the digital AV interface 25 and judges contents of a digital video signal and a digital audio signal received by the digital AV interface 25. The content information includes type information of a content of, for example, graphics, a photo, a cinema, and a game. The external apparatus 28 transmits the content information to the television receiver apparatus 10 via the digital AV interface 25.

The setting reception module 262 receives image quality adjustment information and sound quality adjustment information from the user via the input interface 23 and judges adjustment contents thereof. The manual adjustment module 263 instructs the image quality adjustment module 180 and the sound quality adjustment module 200 to respectively perform an image quality adjustment and a sound quality adjustment based on the adjustment contents judged by the setting reception module 262.

The automatic adjustment module 264 instructs the image quality adjustment module 180 and the sound quality adjustment module 200 to respectively perform an image quality adjustment and a sound quality adjustment based on an image quality adjustment content and a sound quality adjustment content defined in the setting table 27a in advance. Specifically, the setting table 27a defines the image quality adjustment content and the sound quality adjustment content that respectively correspond to various types of information included in the content information in advance, and the automatic adjustment module 264 automatically executes the image quality adjustment and the sound quality adjustment based on those definitions.

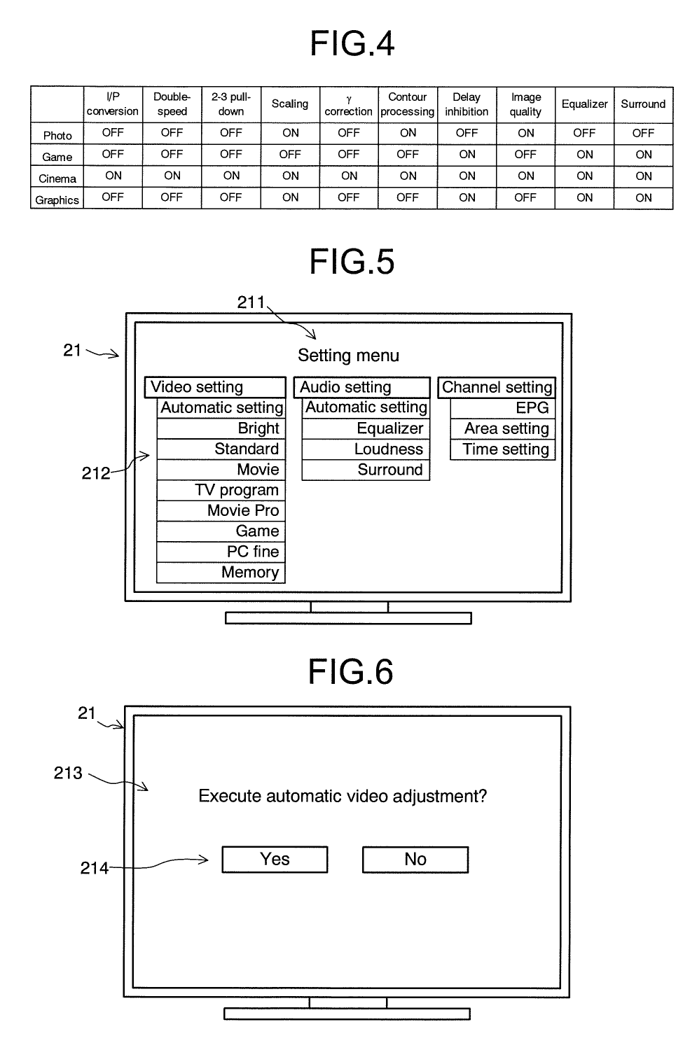

FIG. 4 is a diagram showing an example of the definitions of the setting table 27a. For example, when the type information is “photo”, the adjustment content is defined as I/P conversion OFF, double-speed processing OFF, 2-3 pull-down processing OFF, scaling ON, gamma correction OFF, contour processing ON, delay inhibition OFF, and image quality setting ON. Further, when the type information is “game”, the adjustment content is defined as I/P conversion OFF, double-speed processing OFF, 2-3 pull-down processing OFF, scaling OFF, gamma correction OFF, contour processing OFF, delay inhibition ON, and image quality setting OFF. Furthermore, when the type information is “cinema”, the adjustment content is defined as I/P conversion ON, double-speed processing ON, 2-3 pull-down processing ON, scaling ON, gamma correction ON, contour processing ON, delay inhibition ON, and image quality setting ON. Lastly, when the type information is “graphics”, the adjustment content is defined as, for an image quality adjustment suited for text information, I/P conversion OFF, double-speed processing OFF, 2-3 pull-down processing OFF, scaling ON, gamma correction OFF, contour processing OFF, delay inhibition ON, and image quality setting OFF.

Subsequently, referring to FIGS. 1 and 2, an operation of the entire television receiver apparatus 10 of this embodiment will be described.

Television broadcast waves received by the antenna 11 are sent to the tuner 12. The tuner 12 tunes in on a predetermined broadcast wave out of the digital broadcast waves transmitted from the antenna 11 and sends the obtained digital broadcast stream to the demultiplexing module 13. The demultiplexing module 13 separates a digital video signal and a digital audio signal multiplexed on the digital broadcast waves and sends them to the video decoder 15 and the audio decoder 16, respectively.

The video decoder 15 uses the functions of the image quality adjustment module 180, the I/P conversion module 181, the double-speed processing module 182, the 2-3 pull-down module 183, the scaling module 184, the γ correction module 185, the contour processing module 186, the delay inhibition module 187, and the image quality setting module 188 to perform video processing on the digital video signal. At this time, the image quality adjustment module 180 controls how and to what extent those functions are to be applied. The digital video signal subjected to the video processing is sent to the display device 21 which then displays the digital video signal as a video.

On the other hand, the audio decoder 16 uses the functions of the equalizer module 201 and the surround module 202 to perform signal processing on the digital audio signal. At this time, the sound quality adjustment module 200 controls how and to what extent those functions are to be applied. The digital audio signal subjected to the signal processing is sent to the speaker 22 which then D/A-converts the digital audio signal and outputs it as audio.

Next, referring to FIGS. 1 to 4, an operation of an automatic adjustment function of an image quality and sound quality in the television receiver apparatus of this embodiment will be described.

The digital AV interface 25 monitors a connection state of the external apparatus 28 and whether an input has been made (Step 300; hereinafter, each step will be denoted like “S300”). When the external apparatus 28 is not connected or there is no signal input from the external apparatus 28 (No in S300), the digital AV interface 25 notifies the content judgment module 261 of “no input”. In this case, if the setting reception module 262 has received an automatic adjustment instruction from the user, the automatic adjustment module 264 instructs the image quality adjustment module 180 and the sound quality adjustment module 200 to adjust an image quality and a sound quality based on a detection result of the optical sensor 24 or the like. Based on the instruction from the automatic adjustment module 264, the image quality adjustment module 180 and the sound quality adjustment module 200 control the module groups under control of those two (e.g., image quality setting module 188) and execute predetermined adjustments.

Further, if the setting reception module 262 has received a manual adjustment instruction from the user, the manual adjustment module 263 instructs the image quality adjustment module 180 and the sound quality adjustment module 200 to adjust an image quality and a sound quality based on a content of the instruction received in advance. Based on the instruction from the manual adjustment module 263, the image quality adjustment module 180 and the sound quality adjustment module 200 control the module groups under control of those two (e.g., image quality setting module 188) and execute predetermined adjustments.

FIG. 5 is a diagram showing an example of a setting menu for performing a manual image quality adjustment and sound quality adjustment. When the user instructs to display a setting menu via the input interface 23, the setting reception module 262 generates display screen information 211 as shown in FIG. 5 and displays it on the display device 21. In the example shown in FIG. 5, presented as a setting menu 212 are setting items of a video setting such as “automatic setting”, “bright”, “standard”, “movie”, “TV program”, “movie professional”, “game”, “PC fine”, and “memory”, setting items of an audio setting such as “automatic setting”, “equalizer”, “loudness”, and “surround”, and setting items of a channel setting such as “EPG”, “area setting”, and “time setting”.

Here, the setting items except “automatic setting”, that is, “bright” that is suited for a bright and punchy video, “standard” that is suited for an indoor use, “movie” that is suited for an indoor use in a dark room or suited for a movie content, “TV program” that is suited for a television program, “movie professional” in which settings preferred by users can be added to “movie”, “game” with an excellent video display response, “PC fine” that is suited for a PC screen, and “memory” with which desired settings can be made, are settings of a manual adjustment mode in which the user can make settings based on a user preference or a type of video source. When the user sets the setting items except “automatic setting” via the input interface 23 such as a remote controller, the setting reception module 262 sends the accepted setting items to the manual adjustment module 263 which then instructs the image quality adjustment module 180 and the sound quality adjustment module 200 to make settings based on the received setting items.

Moreover, “automatic setting” is a setting of an automatic adjustment mode in which the television receiver apparatus 10 automatically adjusts an image quality and a sound quality based on an installation environment and a type of video. When the user sets “automatic setting”, the setting reception module 262 instructs, for example, the automatic adjustment module 264 to perform an automatic adjustment, and the automatic adjustment module 264 instructs the image quality adjustment module 180 and the sound quality adjustment module 200 to make settings based on a detection result of the optical sensor 24 or the like.

When the external apparatus 28 is connected to the digital AV interface 25 and a digital video signal or a digital audio signal is sent from the external apparatus 28 (Yes in S300), the content judgment module 261 judges whether the setting reception module 262 has received an automatic adjustment instruction from the user, that is, whether a mode is the automatic adjustment mode for automatically adjusting an image quality and a sound quality (S302).

If the setting reception module 262 has not received an automatic adjustment instruction (No in S302), the manual adjustment module 263 instructs the image quality adjustment module 180 and the sound quality adjustment module 200 to adjust an image quality and a sound quality based on a content of the instruction received in advance. Based on the instruction from the manual adjustment module 263, the image quality adjustment module 180 and the sound quality adjustment module 200 control the module groups under control of those two and execute predetermined adjustments (S303).

If the setting reception module 262 has received an automatic adjustment instruction from the user in advance (Yes in S302), the setting reception module 262 confirms the user on whether to execute the automatic adjustment based on the type information sent from the digital AV interface 25. Specifically, the setting reception module 262 generates display screen information 213 as shown in FIG. 6 and displays it on the display device 21. In the example shown in FIG. 6, the setting reception module 262 causes the display device 21 to display, as an inquiry menu 214, an image that prompts the user to select whether to execute the image quality adjustment (S304).

After causing the display device 21 to display the inquiry menu 214, the setting reception module 262 is put to a standby mode to stand by for a user instruction (S306). When the user selects that an automatic adjustment is unnecessary, that is, selects “No” shown in FIG. 6 via the input interface 23 (No in S306), the automatic adjustment module 264 instructs the image quality adjustment module 180 and the sound quality adjustment module 200 to adjust an image quality and a sound quality without using the type information. Based on the instruction from the automatic adjustment module 264, the image quality adjustment module 180 and the sound quality adjustment module 200 control the module groups under control of those two and execute adjustments that do not use type information, such as image quality setting processing by the image quality setting module 188 (S307). At this time, the automatic adjustment module 264 may instruct image quality setting processing that is based on a detection result of the optical sensor 24 or the like.

Specifically, in the television receiver apparatus of this embodiment, even when the user instructs an automatic adjustment of an image quality or the like in advance, the user can issue a reinstruction on whether to perform an automatic adjustment based on information from the digital AV interface 25. Since various information apparatuses are conceivable as an apparatus to be connected to the digital AV interface 25 as the external apparatus 28, it becomes possible for the user to perform a more-appropriate adjustment of an image quality or the like by the “reinstruction”. It should be noted that the processes of Steps 304 and 306 may be omitted for improving user-friendliness.

When the user selects execution of an automatic adjustment, that is, selects “Yes” shown in FIG. 6 via the input interface 23 (Yes in S306), the content judgment module 261 judges whether type information is sent from the digital AV interface 25 (S308).

When it is judged that the type information is not sent from the digital AV interface 25 (No in S308), the automatic adjustment module 264 instructs the image quality adjustment module 180 and the sound quality adjustment module 200 to adjust an image quality and a sound quality without using the type information. Specifically, since type information from the digital AV interface 25 is not obtained, an automatic adjustment that is based on processing other than the video processing that uses the type information (e.g., image quality setting processing by image quality setting module 188) is executed as in Step 307. At this time, the automatic adjustment module 264 may instruct image quality setting processing that is based on a detection result of the optical sensor 24 or the like (S309).

When it is judged that the type information is sent from the digital AV interface 25 (Yes in S308), the content judgment module 261 judges whether the sent digital video signal is a signal on a moving image based on the type information from the digital AV interface 25 (S310).

When the sent digital video signal is not a signal on a moving image (No in S310), the content judgment module 261 instructs the automatic adjustment module 264 to make a still image setting. The instructed automatic adjustment module 264 reads out a setting corresponding to “photo” from the setting table 27a and instructs the image quality adjustment module 180 and the sound quality adjustment module 200 to make settings (S311).

In the image quality setting, the image quality adjustment module 180 stops the operations of, for example, the I/P conversion module 181, the double-speed processing module 182, the 2-3 pull-down module 183, the γ correction module 185, and the delay inhibition module 187. Specifically, the image quality adjustment module 180 optimizes an image quality by stopping the functions of the modules for an image quality adjustment specializing in moving images. The digital video signal received by the digital AV interface 25 is subjected to, for example, image quality adjustment processing by the scaling module 184, the contour processing module 186, and the image quality setting module 188 and sent to the display device 21.

Similarly, in the sound quality setting, the sound quality adjustment module 200 stops the functions of, for example, the equalizer module 201 and the surround module 202. As a result, the digital audio signal sent from the digital AV interface 25 is sent as it is to the speaker 22.

When the sent digital video signal is a signal on a moving image (Yes in S310), the content judgment module 261 judges whether the sent digital video signal is a signal on a game video based on the type information from the digital AV interface 25 (S312).

When the sent digital video signal is a signal on a game video (Yes in S312), the content judgment module 261 instructs the automatic adjustment module 264 to make a game video setting. The instructed automatic adjustment module 264 reads out a setting corresponding to “game” from the setting table 27a and instructs the image quality adjustment module 180 and the sound quality adjustment module 200 to make settings (S313).

In the image quality setting, the image quality adjustment module 180 stops the operations of, for example, the I/P conversion module 181, the double-speed processing module 182, the 2-3 pull-down module 183, the scaling module 184, the γ correction module 185, the contour processing module 186, and the image quality setting module 188. In other words, the image quality adjustment module 180 stops the processing that delays video display out of the functions of the modules for an image quality adjustment specializing in moving images, and performs video signal processing so as to suppress sharpness in a video. The digital video signal received by the digital AV interface 25 is subjected to, for example, image quality adjustment processing by the delay inhibition module 187 and sent to the display device 21.

Similarly, in the sound quality setting, the sound quality adjustment module 200 turns on the functions of, for example, the equalizer module 201 and the surround module 202. As a result, the digital audio signal sent from the digital AV interface 25 is subjected to, for example, sound quality adjustment processing by the equalizer module 201 and the surround module 202 and sent to the speaker 22.

When the sent digital video signal is not a signal on a game video (No in S312), the content judgment module 261 judges whether the sent digital video signal is a signal on a movie based on the type information from the digital AV interface 25 (S314).

When the sent digital video signal is a signal on a movie (Yes in S314), the content judgment module 261 instructs the automatic adjustment module 264 to make a movie video setting. The instructed automatic adjustment module 264 reads out a setting corresponding to “cinema” from the setting table 27a and instructs the image quality adjustment module 180 and the sound quality adjustment module 200 to make settings (S315).

In the image quality setting, the image quality adjustment module 180 subjects the digital video signal to image quality adjustment processing after making all the functions from, for example, the I/P conversion module 181 to the image quality setting module 188 effective and sends the processed digital video signal to the display device 21. Similarly, in the sound quality setting, the sound quality adjustment module 200 subjects the digital audio signal to sound quality adjustment processing after making the functions of, for example, the equalizer module 201 and the surround module 202 effective and sends the processed digital audio signal to the speaker 22.

On the other hand, when the sent digital video signal is not a signal on a movie (No in S314), the content judgment module 261 instructs the automatic adjustment module 264 to make a graphics video setting. The instructed automatic adjustment module 264 reads out a setting corresponding to “graphics” from the setting table 27a and instructs the image quality adjustment module 180 and the sound quality adjustment module 200 to make settings (S316).

In the image quality setting, the image quality adjustment module 180 subjects the digital video signal to image quality adjustment processing after turning off all the functions except those of, for example, the scaling module 184 and the delay inhibition module 187 and sends the processed digital video signal to the display device 21. Similarly, in the sound quality setting, the sound quality adjustment module 200 subjects the digital audio signal to sound quality adjustment processing after making all the functions effective, for example, and sends the processed digital audio signal to the speaker 22.

As described above, according to the television receiver apparatus 10 of this embodiment, since a video processing content is controlled based on the type information included in the content information transmitted from the external apparatus via the digital AV interface 25, an image quality adjustment appropriate for a content can be realized. Although digital video signals and audio signals are exchanged via the digital AV interface 25 in the descriptions above, analog video signals and audio signals may be exchanged instead.

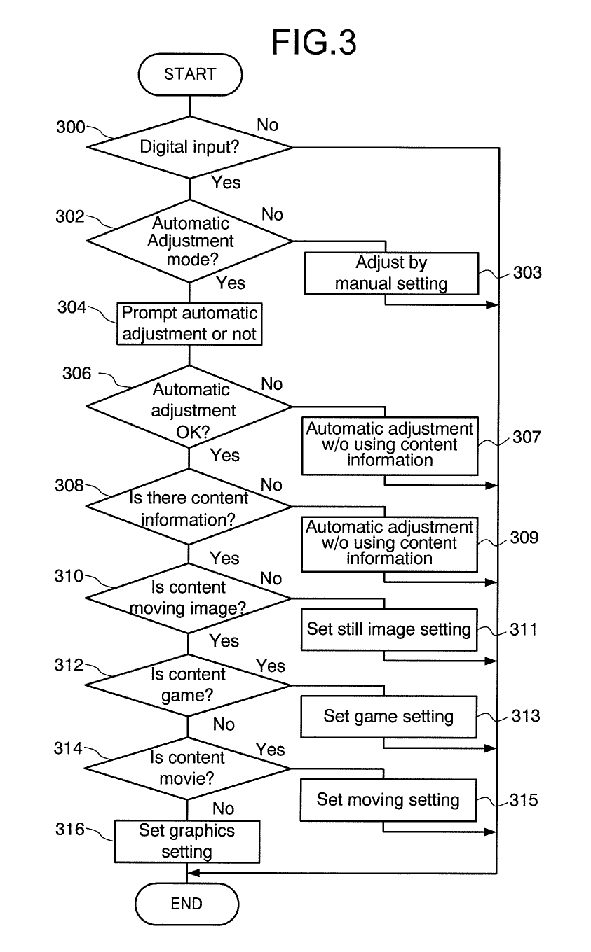

It should be noted that in the above embodiment, the image quality and sound quality adjustments are carried out automatically using the content information obtained from the digital AV interface 25 when the video setting is “automatic setting”, that is, in the automatic adjustment mode. However, that is not limited thereto, and the television receiver apparatus of the above embodiment may carry out an operation from which Step 302 (or Steps 302 to 306) shown in FIG. 3 is omitted, for example. In this case, irrespective of the existing setting contents in the video setting shown in FIG. 5, the content judgment module 261 can instruct the automatic adjustment module 264 to make an image quality setting based on type information sent from the digital AV interface 25, an installation environment, or the like. In other words, even when the user has made an arbitrary video setting, control of video processing that is based on type information from the digital AV interface 25 can be performed automatically.

In general, when a content of a content is judged directly from a digital video signal, the content cannot be judged unless the digital video signal is decoded into a video signal in a frame unit. As a result, since the content cannot be judged before the video processing reaches a final stage, a timing to apply the module groups that undertake the image quality adjustment and sound quality adjustment or a timing to control the module groups is delayed. Since a content of a content transmitted from the external apparatus can be received together with a digital video signal and the like via the digital AV interface in the television receiver apparatus of the above embodiment, an efficient image quality adjustment with a suppressed processing delay, or the like can be realized.

In the example shown in FIG. 4, all the various types of video processing from the I/P conversion processing to the image quality setting processing have been controlled based on the type information transmitted via the digital AV interface. However, that is not limited thereto, and it is also possible to set the image quality setting processing to be constantly on and control the processing from the I/P conversion processing to the delay inhibition processing based on the type information. In this case, an image quality adjustment on brightness, a color temperature, sharpness, and the like can be made even when content information cannot be obtained in Step 307 or 309 shown in FIG. 3. The image quality adjustment may be carried out automatically based on a video signal, a detection result of the optical sensor, and the like.

According to the television receiver apparatus of the above embodiment, a content of a content transmitted from the external apparatus is received via the digital AV interface and the video processing contents shown in FIG. 4 are controlled based on the content of the transmitted content. Therefore, it is possible to prevent a video breakage from being caused in both cases of a moving image and a still image, and also prevent a video delay from occurring in the case of a game content.

Moreover, when a digital video signal or the like is received from the external apparatus via the digital AV interface 25, the television receiver apparatus of the above embodiment can prompt the user to instruct whether to continue the automatic adjustment even when the user has set the adjustment on an image quality or the like to automatic setting. By such an operation, a reproduction of a digital video signal from an external apparatus that is different from a normal television reception can be realized by a more-favorable image quality adjustment or the like.

Furthermore, according to the television receiver apparatus of the above embodiment, since the type information included in the content information is set as a category like a still image, graphics, a movie, and a game that is related to the number of setting items on the image quality adjustment and the sound quality adjustment, the type information can be directly linked with processing control of the image quality adjustment and the sound quality adjustment based on the content information.

According to the above embodiment, an image quality adjustment and the like can be carried out automatically even when program information is not included in a video stream.

While certain embodiments have been described, these embodiments have been presented by way of example only, and are not intended to limit the scope of the inventions. Indeed, the novel methods and apparatus described herein may be embodied in a variety of other forms; furthermore, various omissions, substitutions and changes in the form of the methods and apparatus described herein may be made without departing from the spirit of the inventions. The accompanying claims and their equivalents are intended to cover such forms or modifications as would fall within the scope and spirit of the inventions.

What is claimed is:

1. A video processing apparatus that includes an interface capable of transmitting a video signal and type information indicating a content of the video signal and reproduces and displays the video signal, comprising:
a setting reception module to accept, from a user, a setting of one of automatic signal processing of the video signal and manual signal processing of the video signal, the automatic signal processing being based on at least environment information indicating a surrounding environment and processing content of the manual signal processing being preset by the user;
a judgment module to judge whether the setting of one of the automatic signal processing and the manual signal processing has been accepted by the setting reception module; and
a signal processing module to execute, when it is judged that the setting of the automatic signal processing has been accepted, the automatic signal processing based on the environment information and the type information.

2. The video processing apparatus according to claim 1, further comprising,
a storage module to store a table registering the type information and a signal processing content of the video signal in association with each other,
wherein the signal processing module executes the automatic signal processing based on the environment information, the type information, and the table.

3. The video processing apparatus according to claim 1,
wherein the type information includes one of categories of a photo video indicating that the content of the video signal is a still image, a game video indicating that the content of the video signal is a game screen, a movie video indicating that the content of the video signal is a movie, and a graphics video indicating that the content of the video signal is mainly text characters.

4. A video processing method that uses a video processing apparatus that includes an interface capable of transmitting a video signal and type information indicating a content of the video signal and reproduces and displays the video signal, the method comprising:
accepting from a user, by a setting reception module, a setting of one of automatic signal processing of the video signal and manual signal processing of the video signal, the automatic signal processing being based on at least environment information indicating a surrounding environment and processing content of the manual signal processing being preset by the user;
judging, by a judgment module, whether the setting of one of the automatic signal processing and the manual signal processing has been accepted by the setting reception module; and
executing, by a signal processing module, when it is judged that the setting of the automatic signal processing has been accepted, the automatic signal processing based on the environment information and the type information.
